(19) United States
(12) Patent Application Publication
(10) Pub. No.: US 2007/0124910 A1
(43) Pub. Date: Jun. 7, 2007

(54) Insertion tool for drywall hanger

(75) Inventors: Francis C. Peterson, Spooner, WI (US); Robert B. Jones, River Forest, IL (US)

Correspondence Address: Robert B. Jones, Suite 1600, 120 South LaSalle Street, Chicago, IL, 60603, US

(73) Assignee: Nesson Enterprises, River Forest, IL (US)

(21) Appl. No.: 11/437,470

(22) Filed: May 19, 2006

Related U.S. Application Data
(63) Continuation-in-part of application No. 10/538,812, filed on Dec. 7, 2005.

(51) Int. Cl. B23P 11/00

(52) U.S. Cl. 29/432

(57) ABSTRACT

A method for installing a hanger in gypsum board wherein the hanger comprises a steel strip bent into a Vee to provide two legs, the first leg being arcuate with a pointed end and functioning as an anchor when installed in the board, and the second leg being straight and having a u-bend formed at its terminus to function as a hook, the method comprising: providing a tool comprising a first leaf and a second leaf formed from flexible strips, the leaves being secured to each other at their distal ends so that the faces of the leaves are urged against each other along their lengths, with the first leaf having a slot formed therein adjacent its proximal end sized to receive therethrough the u-bend at the terminus of the second leg of the hanger; inserting the u-bend of the hanger through the slot so that the u-bend is captured between the leaves; placing the tool against the wall of the board with the outer face of the second leaf in contact with the wall and with the pointed end of the first leg of the hanger in contact with the wall; and progressively driving the pointed end of the first leg of the hanger into the board until the hanger is seated.

### FIELD OF THE INVENTION AND CROSS REFERENCE TO RELATED APPLICATIONS

The present invention relates generally to hangers for installation in gypsum board (drywall) from which pictures, mirrors and the like are hung. More particularly, it relates to a novel insertion tool for installing a hanger which is the subject matter of co-pending application Ser. No. 10/538,812, which is incorporated herein in its entirety.

### BACKGROUND OF THE INVENTION

The use of gypsum board for interior walls and ceilings of structures is ubiquitous. Walls and ceilings may be finished in a fraction of the time required for lathe and plaster finishing.

Along with its many advantages, gypsum board has severe limitations with respect to its ability to support pictures, mirrors and the like. Unless a hanger is positioned directly over a stud, into which screws of nails may be driven, special fixtures are required. A common practice is to drill a hole through the board, insert an appropriately sized plastic anchor into the board, and drive a screw into the anchor to which the hanger is attached. Other devices include a self-tapping screw which simultaneously cuts a hole and screws into the board. Yet other hangers comprise a nail driven into the board at an acute angle from which a hook is suspended.

All of the prior art devices have disadvantages. Drilling a hole in the board produces a fine white dust which is difficult to clean up. Moreover, when prior art hangers are removed, a scar is left in the board which must be patched with joint compound or the like, followed by sanding and painting to match the color of the wall. In general, installing or removing prior art hangers is a messy job.

### GENERAL DESCRIPTION OF THE INVENTION

In accordance with the present invention, there is provided a hanger constructed in accordance with the teachings of application Ser. No. 10/538,812. The hanger comprises a steel strip bent into a Vee to provide two legs. The first leg is arcuate and functions as an anchor when properly inserted into gypsum board. The second leg is straight, with a hook or U-bend formed at its terminus for engaging the wire on which the picture or mirror is suspended. An installation tool constructed in accordance with the present invention is provided which enables the arcuate leg of the hanger to be driven into the gypsum board along an arcuate path until the second leg is brought firmly against the surface of the board. The installation tool is then removed, leaving the hook of the hanger ready to receive the suspension wire. If the hanger must be removed or relocated, the hanger is readily removable from the board by rotating it out along the same path as it was inserted, leaving a minimally perceptible scar in the board. Moreover, if the hanger is removed only to reposition it, it may be reinserted as little as ¼-inch away from its previous location, a feature not achievable with prior art hangers.

### DETAILED DESCRIPTION OF THE INVENTION

The structure of the installation tool of the present invention will become readily apparent from the following description and drawing, in which:

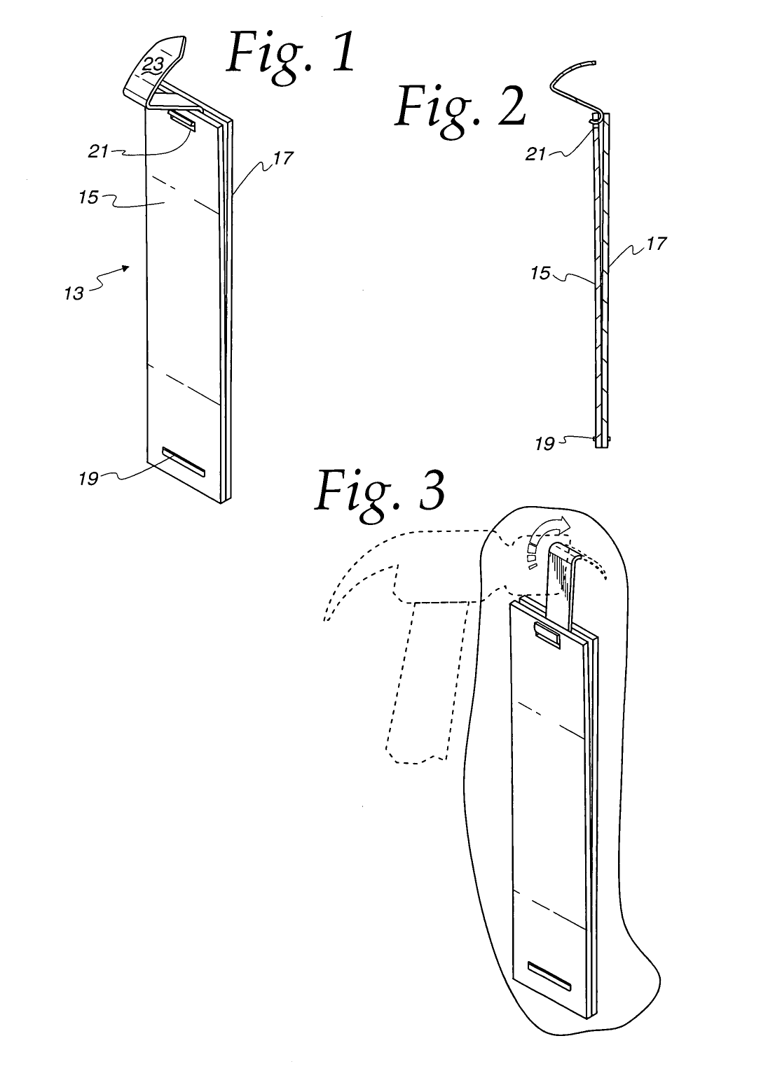

FIG. 1 is a perspective view of an installation tool in accordance with the present invention with the hanger of application Ser. No. 10/538,812;

FIG. 2 is a side cross-sectional view of the installation tool of FIG. 1; and

FIG. 3 is a fragmentary view of the installation method of the present invention, showing the hanger in its inserted position in the gypsum board.

As shown in FIG. 1, there is provided an installation tool 13 comprising an outer leaf 15 and an inner leaf 17 (the inner leaf being the one in confronting relation with the wall). The leaves are affixed to each other at their distal ends by a fastener 19. The leaves are formed from strips of flexible material, such as polyethylene, and in such case the fastener may comprise a staple clinched so as to hold the leaves in deformable facing relation.

A slot 21 is provided near the upper end of the outer leaf 15, which is sized to receive the u-bend formed in the distal end of the hanger 23 as best seen in FIG. 2. When the hanger 23 is inserted into the slot 21 it is resiliently captured between the leaves 15 and 16 of the installation tool, and free to pivot around the center of curvature of the u-bend.

The method of insertion of the hanger into gypsum board will next be described. The installation tool is placed against the board wall in the position shown in FIG. 2, and the hanger is lightly tapped with a hammer to drive the pointed end of the hanger into the board until the face of its second leg is seated against the wall (see FIG. 3). The installation tool is then removed by rotating it away from the wall about the u-bend of the hanger.

Once installed, the hanger of the present invention is able to support surprisingly large loads. A hanger ¼-inch wide readily supports a twenty pound load. Using two such hangers, a forty pound mirror, for example, may safely be hung. Moreover, the load-bearing capacity of the hanger is independent of the thickness of the gypsum board; a twenty pound load can be supported on ¼-inch board as readily as on ⅝-inch board.

The drawings and the foregoing description are not intended to represent the only forms of the invention in regard to the details of its construction and manner of operation. Changes in form and in the proportion of parts, as well as the substitution of equivalents, are contemplated as circumstances may suffice to render expedient; and although specific terms have been employed, they are intended in a generic and descriptive sense only and not for the purposes of limitation, the scope of the invention being delineated by the following claims.

What is claimed is:

1. An installation tool for installing a hanger in gypsum board wherein the hanger comprises a steel strip bent into a Vee to provide two legs, the first leg being arcuate with a pointed end and functioning as an anchor when installed in the board, and the second leg being straight and having a u-bend formed at its terminus to function as a hook, the installation tool comprising:
a first leaf and a second leaf formed from flexible strips;
said first and second leaves being secured to each other at their distal ends so that the faces of said leaves are urged against each other along their lengths;
said first leaf having a slot formed therein adjacent its proximal end sized to receive therethrough the u-bend at the terminus of the second leg of the hanger.

2. The installation tool of claim 1 wherein said leaves are of substantially equal length.

3. The installation tool of claim 1 wherein said leaves are formed from polymeric plastic strips.

4. A method for installing a hanger in gypsum board wherein the hanger comprises a steel strip bent into a Vee to provide two legs, the first leg being arcuate with a pointed end and functioning as an anchor when installed in the board, and the second leg being straight and having a u-bend formed at its terminus to function as a hook, the method comprising:
providing a tool comprising a first leaf and a second leaf formed from flexible strips, the leaves being secured to each other at their distal ends so that the faces of the leaves are urged against each other along their lengths, with the first leaf having a slot formed therein adjacent its proximal end sized to receive therethrough the u-bend at the terminus of the second leg of the hanger;
inserting the u-bend of the hanger through the slot so that the u-bend is captured between the leaves;
placing the tool against the wall of the board with the outer face of the second leaf in contact with the wall and with the pointed end of the first leg of the hanger in contact with the wall; and
progressively driving the pointed end of the first leg of the hanger into the board until the hanger is seated.
